(19) United States
(12) Patent Application Publication
(10) Pub. No.: US 2017/0325492 A1
(43) Pub. Date: Nov. 16, 2017

(54) Nutritional Compositions

(71) Applicant: ABBOTT LABORATORIES, ABBOTT PARK, IL (US)

(72) Inventors: Deborah STROZIER, Westerville, OH (US); Steven HERTZLER, Worthington, OH (US); Jeffrey SALYERS, Columbus, OH (US)

(21) Appl. No.: 15/520,691

(22) PCT Filed: Oct. 20, 2015
(86) PCT No.: PCT/US2015/056401

§ 371 Date: Apr. 20, 2017

Related U.S. Application Data
(60) Provisional application No. 62/073,341, filed on Oct. 31, 2014.

(51) Int. Cl. A23L 33/19; A23L 33/22; A23L 33/10; A23L 33/00; A23L 33/185

(52) U.S. Cl. CPC A23L 33/19; A23L 33/185; A23L 33/40; A23L 33/10; A23L 33/30; A23L 33/22; A23V 2002/00

(57) ABSTRACT

Nutritional compositions provide a sustained protein profile to an individual while having an enhanced sensory performance. The nutritional compositions can be in the form of a nutritional powder including a protein system having a fast digesting protein source, an intermediate digesting protein source, and a slow digesting protein source.

### CROSS-REFERENCE TO RELATED APPLICATIONS

This application claims priority to and any benefit of U.S. Provisional Patent Application No. 62/073,341, filed Oct. 31, 2014, the content of which is incorporated herein by reference in its entirety.

### TECHNICAL FIELD

The present disclosure is directed to nutritional compositions having a sustained protein profile. The nutritional compositions may also be used for achieving lean body goals and for managing hunger in an adult subject.

### BACKGROUND

Use of nutritional powders for providing various individuals with sole or supplemental nutrition is known. Often these powders are reconstituted with water or other aqueous liquid to form a nutritional liquid or beverage. These powders most often contain varying amounts and types of proteins, carbohydrates, lipids, vitamins, and minerals, all depending largely upon the nutritional needs of the intended user.

### SUMMARY

It has been found that embodiments of the inventive nutritional compositions, according to the present disclosure, have enhanced dispersibility and sensory performance. It has further been found that use of a protein system comprising proteins having varying rates of digestion aids in the management of hunger by providing a steady supply of amino acids to the muscles of a subject.

In one embodiment, a powdered nutritional composition comprises, per serving, 55-70 weight % of a protein system; and 10-25 weight % of a fiber source, wherein the powdered nutritional composition provides no more than 100 calories per serving. The protein system comprises a fast digesting protein source, an intermediate digesting protein source, and a slow digesting protein source. The powdered nutritional composition may also comprise 0.1-2 weight % of a gum system.

In one embodiment, a method of managing hunger in a subject is provided. The method comprises reconstituting a serving of a powdered nutritional composition to form a serving of a liquid nutritional composition and administering the liquid nutritional composition to the subject. The powdered nutritional composition comprises, per the serving of the powdered nutritional composition, 55-70 weight % of a protein system; and 10-25 weight % of a fiber source, wherein the powdered nutritional composition provides no more than 100 calories per serving. The protein system comprises a fast digesting protein source, an intermediate digesting protein source, and a slow digesting protein source. The powdered nutritional composition may also comprise 0.1-2 weight % of a gum system.

### DETAILED DESCRIPTION

Embodiments of the present disclosure provide nutritional compositions having a sustained protein profile for managing hunger in a subject. The embodiments comprise a combination of a protein system, a gum system, and a fiber source. The embodiments provide no more than 100 calories per serving of the nutritional composition to a subject. The embodiments may be in the form of a reconstitutable powder or ready-to-drink liquid form. The disclosed embodiments have enhanced dispersion and have a pleasing mouthfeel and taste profile that encourage consumption thereof.

The term “nutritional composition” as used herein, unless otherwise specified, refers to nutritional products in various forms including, but not limited to, liquids, solids, powders, semi-solids, semi-liquids, nutritional supplements, and any other nutritional food product known in the art. A nutritional composition in powder form may often be reconstituted to form a nutritional composition in liquid form. The nutritional compositions disclosed herein are generally suitable for oral consumption by a human.

The terms “nutritional powder” and “reconstitutable powder” as used herein, unless otherwise specified, refer to nutritional compositions in flowable or scoopable form that can be reconstituted with water or another aqueous liquid prior to consumption and include both spray dried and drymixed/dryblended powders.

The term “nutritional liquid” as used herein, unless otherwise specified, refers to nutritional compositions in ready-to-drink liquid form, nutritional compositions in concentrated liquid form, and nutritional liquids made by reconstituting nutritional powders described herein prior to use. The nutritional liquid may also be formulated as a suspension, an emulsion, a solution, and so forth.

The terms “administer,” “administering,” “administered,” and “administration” as used herein, unless otherwise specified, should be understood to include providing a composition to an individual, the act of consuming a composition, and combinations thereof.

The term “serving” as used herein, unless otherwise specified, is intended to be construed as any amount which is intended to be consumed by an individual in one sitting or within 15-30 minutes or less.

The term “adult subject” as used herein, unless otherwise specified, refers to a human having an age of 18 years or older.

The compositions according to certain embodiments of this disclosure include those suitable for oral administration. “Oral administration” as used herein includes any form of administration in which the composition passes through the esophagus of the individual.

The term “digested” or “digestion” as used herein, unless otherwise specified, when referring to protein or combinations of protein, refers to the rate that the protein, the amino acids that make-up the protein, or both are digested after consumption by a user. The term may also refer to the rate that the protein, the amino acids that make-up the protein, or both are taken up into the blood stream for use in, for example, muscle protein synthesis.

The term “sustained protein profile” as used herein, unless otherwise specified, refers to a combination of proteins that includes a source of protein that is rapidly digested by an individual, a source of protein that is digested at an intermediate rate by an individual, and a source of protein that is slowly digested by an individual. The terms rapidly digested, intermediate rate of digestion, and slowly digested refer to digestion rates that are relative to one another. Therefore, the term refers to a protein system that provides a relatively high level of protein swiftly after consumption, as well as providing a relatively high level of protein over a relatively prolonged period of time. In certain embodiments, the term refers to a protein system including a first source of protein having a rapid rate of digestion X, a second source of protein having an intermediate rate of digestion Y, and a third source of protein having a slow rate of digestion Z, wherein X>Y>Z.

The term “highly dispersible” as used herein, unless otherwise specified, refers to the quality of a mixture of the powder and an aqueous liquid, often water. A highly dispersible powder is one which can readily be mixed with water or another aqueous liquid. In addition, in certain embodiments, a highly dispersible powder may remain in a stable aqueous suspension (i.e., very little sedimentation) for more than 30 minutes after initial reconstitution, including remaining in suspension for more than 1 hour after initial reconstitution, including up to 2 hours after initial reconstitution.

The embodiments of nutritional compositions disclosed herein exhibit enhanced dispersion and sensory performance. The nutritional compositions promote satiety which aids in managing hunger and in obtaining the lean body goals of a subject. The nutritional compositions also have an appealing mouthfeel. Recently, it has been shown that hunger can be attenuated via achieving blood levels of certain amino acids (such as, for example, leucine) over prolonged or sustained periods. The nutritional compositions disclosed herein sufficiently provide a steady supply of amino acids to the muscles of a subject by providing proteins digested at varying rates.

In certain embodiments, the nutritional compositions are in the form of a reconstitutable powder. These nutritional powders may be reconstituted with any suitable liquid, such as water or juice, prior to use, and may comprise the embodied compositions disclosed herein. In certain embodiments, the nutritional powders are reconstituted in 8 ounces of liquid.

In one embodiment, the nutritional composition is a powdered nutritional composition. The nutritional composition may be particularly effective in aiding a subject to meet his or her lean body goals by promoting satiety to manage hunger. The powdered nutritional composition comprises, per serving, 55-70 weight % of a protein system; and 10-25 weight % of a fiber source, and provides no more than 100 calories per serving. The powdered nutritional composition may also comprise 0.1-2 weight % of a gum system.

The protein system comprises a fast digesting protein source, a protein source with an intermediate rate of digestion, and a slow digesting protein source. In certain embodiments, a protein with a fast rate of digestion is one which exhibits a 3-hour postprandial blood leucine area under the curve (on a per gram of protein basis) of greater than 386 nmol·mL⁻¹·min⁻¹, a protein with an intermediate rate of digestion is one which exhibits a 3-hour postprandial blood leucine area under the curve (on a per gram of protein basis) of approximately 205-250 nmol·mL⁻¹·min⁻¹, and a protein with a slow rate of digestion is one which exhibits a 3-hour postprandial blood leucine area under the curve (on a per gram of protein basis) of less than 136 nmol·mL⁻¹·min⁻¹. In some embodiments, the protein with a slow rate of digestion is one which exhibits a 3-hour postprandial blood leucine area under the curve (on a per gram of protein basis) of between 114-136 nmol·mL⁻¹·min⁻¹.

In some embodiments, the amount of protein may also be expressed as a percentage of the total weight of the nutritional composition. In certain embodiments, the protein system is at least 70 weight % of the powdered nutritional composition. In certain embodiments, the protein system is at least 55 weight % of the powdered nutritional composition. In other embodiments, the protein system provides the subject with at least 15 grams of total protein per serving of the powdered nutritional composition. In other embodiments, the protein system provides a release of amino acids into the bloodstream over a period of about 1-8 hours. The amount of protein may also be expressed as a percentage of the total calories present in the nutritional composition. In certain embodiments, protein is present in an amount of 60-70% of the total calories in the nutritional composition.

In certain embodiments, the nutritional composition includes a protein system with a sustained protein profile. The protein system includes a first source of protein having a rapid rate of digestion X, a second source of protein having an intermediate rate of digestion Y, and a third source of protein having a slow rate of digestion Z. In certain embodiments, X>Y>Z. In certain embodiments, X>>Y>>Z.

In certain embodiments, the nutritional composition comprises a protein system made up of a combination of proteins from more than one source. In certain embodiments of the nutritional composition, the protein system is the sole source of protein in the nutritional composition. In other embodiments, the nutritional composition comprises a source of protein in addition to the protein system.

In certain embodiments, the fast digesting protein is selected from the group consisting of whey protein, whey protein concentrate, whey protein isolate, whey protein hydrolysate, and combinations thereof. In certain embodiments, the fast digesting protein is 55% or less of the total protein in the protein system. In other embodiments, the fast digesting protein is 35% or less of the total protein in the protein system.

In certain embodiments, the nutritional composition comprises a source of protein that is digested at an intermediate rate relative to the fast and slow digesting proteins. The intermediate digestion rate protein may be provided by one or more sources.

In certain embodiments, the intermediate digesting protein is selected from the group consisting of soy protein, soy protein concentrate, soy protein isolate, soy flours, and combinations thereof. In certain embodiments, the protein with an intermediate rate of digestion is 55% or less of the total protein in the protein system. In other embodiments, the protein with an intermediate rate of digestion is 25% to 55% of the total protein in the protein system. In other embodiments, the protein with an intermediate rate of digestion is 30% to 40% of the total protein in the protein system.

In certain embodiments, the nutritional composition comprises a source of protein that is digested at a slow rate relative to the proteins with fast or intermediate rates of digestion. The slow digesting protein may be provided by one or more sources.

In certain embodiments, the slow digesting protein is selected from the group consisting of casein, milk protein, milk protein concentrate, and combinations thereof. In some embodiments, the slow digesting protein is micellar casein. In other embodiments, the slow digesting protein is milk protein concentrate. In still other embodiments, the slow digesting protein is beef protein.

The milk protein may be provided by a single source or a combination of sources. In certain embodiments, the nutritional composition comprises a source of milk protein comprising both casein protein and whey protein. In certain embodiments, the source of milk protein is milk protein concentrate.

The term milk protein concentrate (MPC) is generally used to refer to a milk protein containing product that has had a considerable amount of the inherent water from ordinary milk removed and also has had the inherent fat from the ordinary milk removed. The term milk protein isolate is generally used to refer to a type of milk protein containing product that has not only had a considerable amount of the inherent water and fat from ordinary milk removed but also a certain amount of inherent lactose removed. In most instances, milk protein isolates can be considered to be a type of further purified MPC. In certain embodiments, the source of milk proteins may be a combination of more than one milk protein source, i.e., wherein the source comprises casein protein, as well as comprising whey protein. MPC is one such source. The protein in MPC generally comprises approximately 80% casein protein and 20% whey protein.

In addition to the protein sources discussed above, in certain embodiments, the nutritional composition may also contain protein from one or more other sources. The one or more other sources of protein may, in certain embodiments, include animal products (e.g., meat, fish, egg albumen), cereals (e.g., rice, corn), vegetables (e.g., soy, pea, potato), and combinations thereof. The additional protein sources can also include free amino acids known for use in nutritional compositions, non-limiting examples of which include L-tryptophan, L-glutamine, L-tyrosine, L-methionine, L-cysteine, L-arginine, and combinations thereof.

In certain embodiments, the nutritional composition comprises a dispersing agent, which improves the dispersibility of the nutritional composition. The dispersing agent may facilitate dispersion of the nutritional composition by a variety of means. For example, the dispersing agent may increase the rate of dispersion. As another example, the dispersing agent may prevent or minimize the number or amount of powder agglomeration that might occur, among others. The average particle size of the dispersing agent may be larger than that of the average particle size of the protein or proteins, and in certain embodiments, the average particle size of the dispersing agent is much larger than that of the protein or proteins. While not intending to be bound by theory, the larger particle size, coupled with the relative ease of dissolution of a dispersing agent, may aid in dispersing and suspending the proteins which generally are more difficult to adequately disperse.

In certain embodiments, the protein system has been instantized with soy lecithin. Instantizing a protein involves coating the protein particles with an emulsifier such as lecithin so that the particles become larger (agglomerated protein particles) to facilitate easier dispersion, thus enhancing mixing. Other exemplary ways of instantizing proteins include agglomerating with maltodextrin solution and wetting the protein prior to drying.

In certain embodiments of the powdered nutritional composition, the gum system comprises at least one of carrageenan and xanthan gum. In certain embodiments of the powdered nutritional composition, the gum system comprises both carrageenan and xanthan gum. In certain embodiments of the powdered nutritional composition, the gum system consists of carrageenan and xanthan gum. The gum system may also act as a stabilizer. In such a case, it is essential that the gum system is adequately dispersed and blended in the final product so that it is effective as a stabilizer. Adequate dispersion of the gum system is also important for the gum system to be effective in promoting desirable mouth feel and viscosity when added to liquid. In certain embodiments, the gum system may represent from about 0.1-2% by weight of the nutritional composition.

In certain embodiments, the nutritional composition comprises a fiber source. The fiber may be provided by one source or, in certain embodiments, by multiple sources of fiber. Fiber is defined as the indigestible portion of food consumed by animals. Non-limiting examples of fibers and sources thereof which may be suitable for use in the embodiments include: fibers such as fructooligosaccharides (FOS), galactooligosaccharides (GOS), beta-glucans, inulin, raffinose, xylose, lignin, and polydextrose. The particular amount of fiber present in the nutritional composition may vary depending upon the nutritional needs of the intended user.

In certain embodiments of the powdered nutritional composition, the fiber source comprises at least one of polydextrose and fructooligosaccharides. In certain embodiments of the powdered nutritional composition, the fiber source consists of polydextrose and fructooligosaccharides. The amount of fiber present in the nutritional composition may also be expressed as a percentage of the total weight of the composition. In some embodiments, the fiber source provides the subject with 20% of the recommended daily value of fiber for an adult subject. In some embodiments, the fiber source is at least 19 weight % of the powdered nutritional composition. In some embodiments, the fiber source provides the subject with at least 5 grams of fiber.

Some embodiments of the powdered nutritional composition comprise a carbohydrate. In certain embodiments, the carbohydrate is selected from the group consisting of fructose, sucrose, maltodextrin, isomaltulose, and combinations thereof.

In certain embodiments, the nutritional composition comprises a carbohydrate component including a source of carbohydrates in an amount sufficient to provide 25% of the calories in the nutritional composition. In certain embodiments, any fiber present in the nutritional composition is included in the total amount of carbohydrates. In such embodiments, the amount of carbohydrates present in the nutritional composition may be expressed as a percentage of the total weight of the nutritional composition. In certain embodiments, wherein the nutritional composition is a nutritional powder, carbohydrates are present in an amount of 35% by weight of the nutritional composition.

Examples of sources of carbohydrates which may be suitable for use in certain embodiments of the nutritional compositions disclosed herein include simple, complex, or variations and combinations thereof. Generally, any source of carbohydrates may be used so long as it is suitable for use in oral nutritional compositions and is otherwise compatible with any other selected ingredients or features present in the nutritional composition. Non-limiting examples of carbohydrates or sources thereof suitable for use in the nutritional compositions disclosed herein include maltodextrin; hydrolyzed or modified starch or cornstarch; glucose polymers; corn syrup; corn syrup solids; rice-derived carbohydrates; sucrose; glucose; fructose; lactose; high fructose corn syrup; honey; and sugar alcohols (e.g., maltitol, erythritol, sorbitol).

The carbohydrates may be provided by one source or multiple sources of carbohydrates. The particular amount of carbohydrates present in the nutritional composition may vary depending upon the nutritional needs of the intended user.

The various embodiments of the nutritional compositions disclosed herein, as well as other contemplated embodiments, may be prepared by any process or suitable method (now known or known in the future) for making a selected product form. Many such techniques are known for any given product form and can easily be applied by one of ordinary skill in the art to the various embodiments presented herein. Examples include dry blending the powder using a ribbon blender or v-blender.

In certain embodiments, the powdered nutritional composition is in the form of a flowable or substantially flowable particulate composition, or at least a particulate composition that may be easily scooped and measured with a spoon or similar device, wherein the composition may be reconstituted with a suitable aqueous fluid, such as water, to form a liquid hydrating composition for oral use. The embodiments include spray dried, agglomerated, dry blended, or other known or otherwise effective particulate forms. The quantity of hydrating powder required to produce a volume suitable for one serving may vary. In certain embodiments of the powdered compositions, a serving may range from 7.5-8.5 grams of the powdered composition.

In certain embodiments, a method of managing hunger in a subject is provided. The method comprises preparing a liquid nutritional composition by dissolving a powdered nutritional composition in a liquid, the powdered nutritional composition comprising any of the embodiments described or otherwise suggested herein, and administering the nutritional composition to the subject, for example, any of the subjects described or otherwise suggested herein. The liquid may be water or any other liquid (e.g., a juice) suitable for dissolving the powdered composition and typically suitable for oral consumption. In certain embodiments, at least 8 ounces of liquid are used to reconstitute the powdered nutritional composition.

In certain embodiments, a serving of the liquid nutritional composition is formed by dissolving about 30-40 grams of the powdered nutritional composition in 8 ounces of liquid. Non-limiting examples of liquid nutritional compositions include snack and meal replacement products; hot or cold beverages; carbonated or non-carbonated beverages; juices or other acidified beverages; milk or soy-based beverages; shakes; coffees; teas; compositions for administration by nasogastric intubation; and so forth. Generally, the liquid nutritional compositions are formulated as suspensions or emulsions, but the liquids can also be formulated in any other suitable form such as clear liquids, solutions, liquid gels, liquid yogurts, and so forth.

In certain embodiments, the nutritional composition is a solid nutritional product. Non-limiting examples of solid nutritional products include snack and meal replacement products, including those formulated as bars; sticks; cookies, breads, cakes, or other baked goods; frozen liquids; candy; breakfast cereals; powders, granulated solids, or other particulates; snack chips or bites; frozen or retorted entrees; and so forth. In certain embodiments, the nutritional composition is in the form of a reconstitutable powder.

In certain embodiments, the nutritional composition may further comprise optional ingredients that may modify the physical, chemical, aesthetic, or processing characteristics of the composition or serve as additional nutritional components when used in the targeted population. Many such optional ingredients are known or otherwise suitable for use in nutritional powders, and may also be used in the nutritional compositions, provided that such optional ingredients are compatible with the essential components described herein, are safe and effective for their intended use, and do not otherwise unduly impair product performance.

Non-limiting examples of such optional ingredients include preservatives, additional antioxidants, emulsifying agents, buffers, colorants, flavors, probiotics, prebiotics, lactoferrin and related derivatives, thickening agents and stabilizers, and so forth.

In certain embodiments, the nutritional composition may further comprise at least one sweetening agent. In certain embodiments, the at least one sweetening agent is at least one sugar alcohol such as maltitol, erythritol, sorbitol, xylitol, mannitol, isolmalt, and lactitol, or at least one artificial or high potency sweetener such as acesulfame K, aspartame, sucralose, saccharin, stevia, tagatose, and combinations thereof. The sweetening agents, especially as a combination of a sugar alcohol and an artificial sweetener, may be especially useful in formulating liquid nutritional compositions having a desirable flavor profile. These sweetener combinations can effectively mask undesirable flavors, for example, as sometimes associated with the addition of vegetable proteins to a liquid nutritional composition.

In certain embodiments, the nutritional composition may comprise a flowing agent or anti-caking agent to retard clumping or caking of a nutritional powder embodiment over time and to make the nutritional powder flow easily from its container. Any flowing or anti-caking agents that are known or otherwise suitable for use in a nutritional powder or product form may be suitable for use herein, non-limiting examples of which include tricalcium phosphate, silicates, and combinations thereof. The concentration of the flowing agent or anti-caking agent in certain embodiments of the nutritional composition varies depending upon the product form, the other selected ingredients, the desired flow properties, and so forth, but can range from 0-1% by weight of the nutritional composition.

In certain embodiments, the nutritional composition may comprise one or more masking agents to reduce or otherwise obscure the effects of any bitter flavors and after taste that may develop in the nutritional compositions over time. Suitable masking agents include natural and artificial sweeteners; sodium sources such as sodium chloride; and combinations thereof. The amount of masking agent added to the nutritional composition may vary depending upon the particular masking agent selected, other ingredients in the formulation, and other formulation or product target variables. Such amounts, however, can range from 0-1.5% by weight of the nutritional composition.

In certain embodiments, the nutritional compositions may be packaged and sealed in single or multi-use containers, and then stored under ambient conditions for up to about 24 months. For multi-use containers, the packages may be opened and then covered for repeated use by the user, provided that the covered package is then stored under ambient conditions (e.g., avoiding extreme temperatures) and the entire contents used within 1-2 months.

The nutritional powder embodiments may be prepared by any known or otherwise effective technique suitable for making and formulating nutritional powders, variations of which may depend upon variables such as the selected ingredient combination, packaging and container selection, and so forth. Such techniques and variations are described in the nutritional art or are otherwise well known to those skilled in the nutritional art. These methods typically involve the initial formation of an aqueous slurry containing carbohydrates, proteins, lipids, stabilizers or other formulation aids, vitamins, minerals, or combinations thereof. The slurry is emulsified, pasteurized, homogenized, and cooled. Various other solutions, mixtures, or other materials may be added to the resulting emulsion before, during, or after further processing. The resulting mixture is then heated and dried into powder form, which may be accomplished by spray drying or other heat-treating methods of forming solid particulates in a powder matrix. Other essential or optional materials may also be added to the formulation by dry blending, agglomerating, or otherwise combining the added material to the forming or just formed solid particulates.

### EXAMPLES

The following examples further describe and demonstrate specific embodiments within the scope of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

Example 1 illustrates an embodiment of a nutritional composition in the form of a nutritional powder. All ingredient amounts are listed as weight percent, unless otherwise specified. The nutritional composition shown in Table 1 is a vanilla flavored nutritional powder formulated for reconstitution into a liquid at a rate of approximately 30 grams per serving of nutritional composition.

TABLE 1

| Ingredient by Common Name | | Percent |
|---|---|---|
| Whey Protein Concentrate | | 29.7920% |
| Whey Protein Concentrate | | |
| Soy Lecithin | | |
| Soy Protein Isolate | | 22.0080% |
| Polydextrose | | 16.7600% |
| Micellar Casein | | 12.0320% |
| Fructose | | 9.3797% |
| Short-Chain Fructooligosaccharides FOS | | 4.0000% |
| LESS THAN 2% OF THE FOLLOWING | | |
| Artificial Flavor | | 1.8000% |
| Art.Butter Vanilla | 1.8000% | |
| Ascorbic Acid | | 1.1250% |
| dl-Alpha-Tocopheryl Acetate | | 0.7800% |
| Salt | | 1.8000% |
| Corn Maltodextrin | | 0.7275% |
| Corn Maltodextrin | 0.6900% | |
| Corn Maltodextrin (Premix) | 0.04% | |
| Carageenan | | 0.3000% |
| Xanthan Gum | | 0.3000% |
| Sucralose | | 0.0547% |
| Acesulfame Potassium | | 0.0437% |
| Thiamine Hydrochloride | | ≦0.01499% |
| Riboflavin | | ≦0.01499% |
| Niacinamide | | ≦0.01499% |
| Pyridoxine Hydrochloride | | ≦0.01499% |
| Folic Acid | | ≦0.01499% |
| Cyanocobalamin | | ≦0.01499% |
| Calcium Pantothenate | | ≦0.01499% |
| TOTAL | | 100.0% |

Example 2 illustrates an embodiment of a nutritional composition in the form of a nutritional powder. All ingredient amounts are listed as weight percent, unless otherwise specified. The nutritional composition shown in Table 2 is a chocolate flavored nutritional powder formulated for reconstitution into a liquid at a rate of approximately 30 grams per serving of nutritional composition.

TABLE 2

| Ingredient by Common Name | | Percent |
|---|---|---|
| Whey Protein Concentrate | | 33.3820% |
| Whey Protein Concentrate | | |
| Soy Lecithin | | |
| Soy Protein Isolate | | 22.4000% |
| Polydextrose | | 15.0467% |
| Fructose | | 7.9100% |
| Micellar Casein | | 6.6600% |
| Cocoa Powder (Processed with Alkali) | | 5.0000% |
| Short-Chain Fructooligosaccharides FOS | | 4.0000% |
| LESS THAN 2% OF THE FOLLOWING | | |
| Ascorbic Acid | | 1.1250% |
| Natural and Artificial Flavor | | 1.0800% |
| Art. Cream Flavor | 0.6300% | |
| N&A Chocolate Flavor | 0.4500% | |
| Salt | | 1.0697% |
| dl-Alpha-Tocopheryl Acetate | | 0.7800% |
| Corn Maltodextrin | | 0.7275% |
| Corn Maltodextrin | 0.6900% | |
| Corn Maltodextrin (Premix) | 0.04% | |
| Carageenan | | 0.3000% |
| Xanthan Gum | | 0.3000% |
| Sucralose | | 0.0677% |
| Acesulfame Potassium | | 0.0540% |
| Thiamine Hydrochloride | | ≦0.01499% |
| Riboflavin | | ≦0.01499% |
| Niacinamide | | ≦0.01499% |
| Pyridoxine Hydrochloride | | ≦0.01499% |
| Folic Acid | | ≦0.01499% |
| Cyanocobalamin | | ≦0.01499% |
| Calcium Pantothenate | | ≦0.01499% |
| TOTAL | | 100.0% |

When formulating a nutritional composition with a variety of protein sources, sensory performance can become an issue as proteins may not completely or adequately disperse when, for example, a powder is reconstituted into a liquid. However, many consumers prefer nutritional compositions that are provided as reconstitutable powders as they often have benefits such as longer shelf life over ready to feed liquids. Sensory descriptive panel testing is a well known method of evaluating nutritional compositions (including reconstituted nutritional powders) for sensory performance and overall desirability. In a typical sensory descriptive panel test, a group of subjects is asked to independently evaluate different samples for aroma, color, flavor, sweetness, thickness, mouthfeel, and aftertaste. Each subject is then asked to rate each of these properties on the following descriptive scale: ½ very slight, 1 slight, 1½ slight to moderate, 2 moderate, 2½ moderate to strong, 3 strong. The mean score for each property is then determined, which provides an assessment of the particular property being evaluated. Below are the results of a sensory panel of certified flavor profilers evaluating the performance of nutritional compositions according to embodiments.

Example 3: Table 3 shows the results for sensory descriptive panel testing of a vanilla flavored nutritional composition reconstituted at a rate of 30 grams per 8 mL.

TABLE 3
Descriptive Sensory Panel Evaluation

| | Vanilla |
|---|---|
| | Flavored |
| | Nutritional |
| sweet | 1½ |
| sour | 1 |
| salt | ½ |
| bitter | ½ |
| vanilla (buttery, fruity, creamy) | 2 |
| starchy | 1 |
| butyric | 1 |
| waxy | ½ |
| whey | ½ |
| cardboardy | ½ |
| drying | 1½ |
| powdery mouthfeel | 1½ |
| syntheic sweetener sensation | 1½ |
| throat catch | |

All percentages, parts, and ratios as used herein are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the embodiments described herein shall include the corresponding plural characteristic or limitation, and vice versa, unless otherwise specified or clearly implied to the contrary by the context in which the reference is made.

All combinations of method or process steps as used herein may be performed in any order, unless otherwise specified or clearly implied to the contrary by the context in which the referenced combination is made.

The embodiments herein may also be substantially free of any optional or selected essential ingredient or feature described herein, provided that the remaining formula still contains all of the required ingredients or features as described herein. In this context, and unless otherwise specified, the term “substantially free” means that the selected composition contains less than a functional amount of the optional or selected ingredient, typically less than 0.1% by weight, and also including 0% by weight of such optional or selected ingredient.

The embodiments described herein may comprise, consist of, or consist essentially of the essential elements and limitations of the invention described herein, as well as any additional or optional ingredients, components, or limitations described herein or otherwise useful in nutritional powder formula applications.

1. A powdered nutritional composition comprising per serving:
55-70 weight % of a protein system, the protein system comprising a fast digesting protein source, an intermediate digesting protein source, and a slow digesting protein source; and 10-25 weight % of a fiber source,
wherein the powdered nutritional composition provides no more than 100 calories per serving.

2. The powdered nutritional composition of claim 1, further comprising 0.1-2 weight % of a gum system.

3. The powdered nutritional composition of claim 1, wherein the fast digesting protein source is selected from the group consisting of whey protein, whey protein concentrate, whey protein isolate, whey protein hydrolysate, and combinations thereof.

4. The powdered nutritional composition of claim 1, wherein the intermediate digesting protein source is selected from the group consisting of soy protein, soy protein concentrate, soy protein isolate, soy flours, and combinations thereof.

5. The powdered nutritional composition of any one of claim 1, wherein the slow digesting protein source is selected from the group consisting of micellar casein, milk protein concentrate, beef protein, and combinations thereof.

6. The powdered nutritional composition of claim 1, wherein the fast digesting protein is 55% or less of the total protein in the protein system.

7. The powdered nutritional composition of claim 1, wherein the fast digesting protein is 35% or less of the total protein in the protein system.

8. The powdered nutritional composition of any one of claim 1, wherein the intermediate digesting protein is 55% or less of the total protein in the protein system.

9. The powdered nutritional composition of claim 1, wherein the intermediate digesting protein is from 25% to 55% of the total protein in the protein system.

10. The powdered nutritional composition of claim 1, wherein the intermediate digesting protein is from 30% to 40% or less of the total protein in the protein system.

11. The powdered nutritional composition of any one of claim 1, wherein the protein system is at least 70 weight % of the powdered nutritional composition.

12. The powdered nutritional composition of any claim 1, wherein the protein system is at least 40 weight % of the powdered nutritional composition.

13. The powdered nutritional composition of claim 1, wherein the protein system provides at least 15 grams of protein per serving of the powdered nutritional composition.

14. The powdered nutritional composition of claim 1, wherein the protein system has been instantized with soy lecithin.

15. The powdered nutritional composition of claim 2, wherein the gum system comprises at least one of carrageenan and xanthan gum.

16. The powdered nutritional composition of claim 1, wherein the fiber source comprises at least one of polydextrose and fructooligosaccharides.

17. The powdered nutritional composition of claim 1, wherein the fiber source provides approximately 20%> of the recommended daily value of fiber for an adult subject.

18. The powdered nutritional composition of claim 1, wherein the fiber source is at least 19 weight % of the powdered nutritional composition.

19. The powdered nutritional composition of claim 1, wherein the fiber source provides at least 5 grams of fiber per serving of the powdered nutritional composition.

20. The powdered nutritional composition of claim 1, comprising a carbohydrate selected from the group consisting of fructose, sucrose, maltodextrin, isomaltulose, and combinations thereof.

21. A method of managing hunger in a subject, the method comprising:
reconstituting a powdered nutritional composition to form a liquid nutritional composition, the powdered nutritional composition comprising, per serving of the powdered nutritional composition:
55-70 weight % of a protein system; and
10-25 weight % of a fiber source;
wherein the powdered nutritional composition provides no more than 100 calories per the serving of the powdered nutritional composition, and
administering the liquid nutritional composition to the subject.

22. The method of claim 21, wherein the powdered nutritional composition further comprises, per serving of the powdered nutritional composition, 0.1-2 weight % of a gum system.

23. The method of claim 21, wherein the powdered nutritional composition further comprises a fast digesting protein source; and wherein the fast digesting protein source is selected from the group consisting of whey protein, whey protein concentrate, whey protein isolate, whey protein hydrolysate, and combinations thereof.

24. The method of claim 21, wherein the powdered nutritional composition further comprises an intermediate digesting protein source; and wherein the intermediate digesting protein source is selected from the group consisting of soy protein, soy protein concentrate, soy protein isolate, soy flours, and combinations thereof.

25. The method of claim 21, wherein the powdered nutritional composition further comprises a slow digesting protein source; and wherein the slow digesting protein source is selected from the group consisting of micellar casein, milk protein concentrate, beef protein, and combinations thereof.

26. The method of claim 21, wherein the protein system supplies a subject with a rise in plasma amino acids above fasting level over a period of about 1-8 hours.

27. The method of claim 21, further comprising instantizing the protein system with soy lecithin.

28. The method of claim 21, wherein the protein system provides at least 15 grams of protein per serving of the powdered nutritional composition.

29. The method of claim 21, wherein a serving of the liquid nutritional composition is formed from about 30 grams of the powdered nutritional composition.

30. The method of claim 21, wherein the powdered nutritional composition is reconstituted using at least 8 ounces of a liquid.

31. The method of claim 30, wherein the liquid is water.

32. The method of claim 23, wherein the fast digesting protein is 40% or less of the total protein in the protein system.

33. The method of claim 23, wherein the fast digesting protein is 35% or less of the total protein in the protein system.

34. The method of claim 24, wherein the intermediate digesting protein is 55% or less of the total protein in the protein system.

35. The method of any one of claim 24, wherein the intermediate digesting protein is from 25% to 55% of the total protein in the protein system.

36. The method of claim 24, wherein the intermediate digesting protein is from 30% to 40% of the total protein in the protein system.

37. The method of claim 21, wherein the protein system is at least 70 weight % of the powdered nutritional composition.

38. The method of claim 21, wherein the protein system is at least 40 weight % of the powdered nutritional composition.

39. The method of claim 22, wherein the gum system comprises at least one of carrageenan and xanthan gum.

40. The method of claim 21, wherein the fiber source comprises at least one of polydextrose and fructooligosaccharides.

41. The method of claim 21, wherein the fiber source provides approximately 2000 of the recommended daily value of fiber for an adult subject.

42. The method of claim 21, wherein the fiber source is at least 19 weight % of the powdered nutritional composition.

43. The method of claim 21, wherein the fiber source provides at least 5 grams of fiber per serving of the powdered nutritional composition.

44. The method of claim 21, wherein the powdered nutritional composition further comprises a carbohydrate selected from the group consisting of fructose, sucrose, maltodextrin, isomaltulose, and combinations thereof.
